(19) United States
(12) Patent Application Publication
(10) Pub. No.: US 2024/0036314 A1
(43) Pub. Date: Feb. 1, 2024

(54) HEAD-UP DISPLAY

(71) Applicant: Panasonic Intellectual Property Management Co., Ltd., Osaka (JP)

(72) Inventors: Kousuke SASAKI, Kanagawa (JP); Daiki KAWAI, Kanagawa (JP)

(73) Assignee: Panasonic Intellectual Property Management Co., Ltd., Osaka (JP)

(21) Appl. No.: 18/221,219

(22) Filed: Jul. 12, 2023

(30) Foreign Application Priority Data
Jul. 29, 2022 (JP) 2022-121393

(51) Int. Cl. G02B 27/01; G02B 7/182; B60K 35/00

(52) U.S. Cl. CPC G02B 27/0149; G02B 7/1821; G02B 27/0101; B60K 35/00; G02B 2027/0154; B60K 2370/1529; B60K 2370/785

(57) ABSTRACT

A head-up display includes: a display device that emits image light; a mirror that reflects the image light; a mirror holder that supports the mirror and includes a rotational shaft; a bearing that rotatably supports the rotational shaft; and a pressing component that presses a portion of the rotational shaft. The rotational shaft includes an eccentric portion including an area in which a distance from a rotation center changes. The pressing component presses the eccentric portion.

### CROSS REFERENCE TO RELATED APPLICATION

The present application is based on and claims priority of Japanese Patent Application No. 2022-121393 filed on Jul. 29, 2022.

### Field

The present disclosure relates to a head-up display including a mirror that reflects image light.

### Background

In a head-up display, a mirror that reflects image light is rotated to adjust a display position that suits a user's eye level. For this reason, the mirror of the head-up display is provided with a rotational shaft for rotating the mirror, and a casing of the head-up display is provided with a bearing for supporting the rotational shaft.

Patent Literature (PTL) 1 discloses a head-up display including a display device (display apparatus) that emits image light, a mirror (movable mirror) that reflects the image light, and a bearing that rotatably supports a rotational shaft of the mirror.

### Citation List

### Patent Literature

PTL 1: Japanese Unexamined Patent Application Publication No. 2021-75248

### SUMMARY

However, the head-up display according to PTL 1 can be improved upon.

In view of this, the present disclosure provides a head-up display capable of improving upon the above related art.

A head-up display according to one aspect of the present disclosure includes: a display device that emits image light; a mirror that reflects the image light; a mirror holder that supports the mirror and includes a rotational shaft; a bearing that rotatably supports the rotational shaft; and a pressing component that presses a portion of the rotational shaft. The rotational shaft includes an eccentric portion including an area in which a distance from a rotation center changes. The pressing component presses the eccentric portion.

A head-up display according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

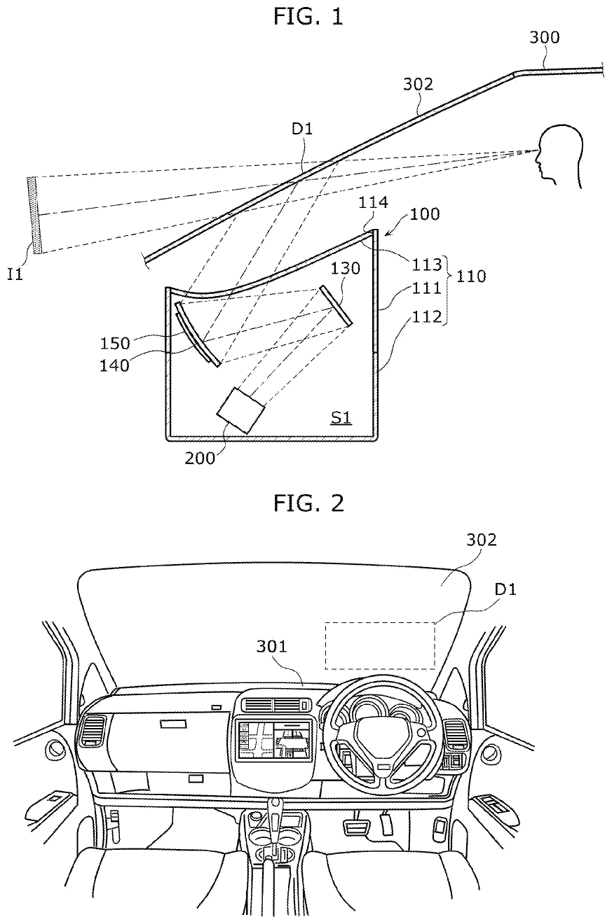

### [FIG. 1]

FIG. 1 is a diagram illustrating an example of usage of a head- up display according to an embodiment.

### [FIG. 2]

FIG. 2 is a diagram illustrating a display area of an image to be displayed by the head-up display according to the embodiment.

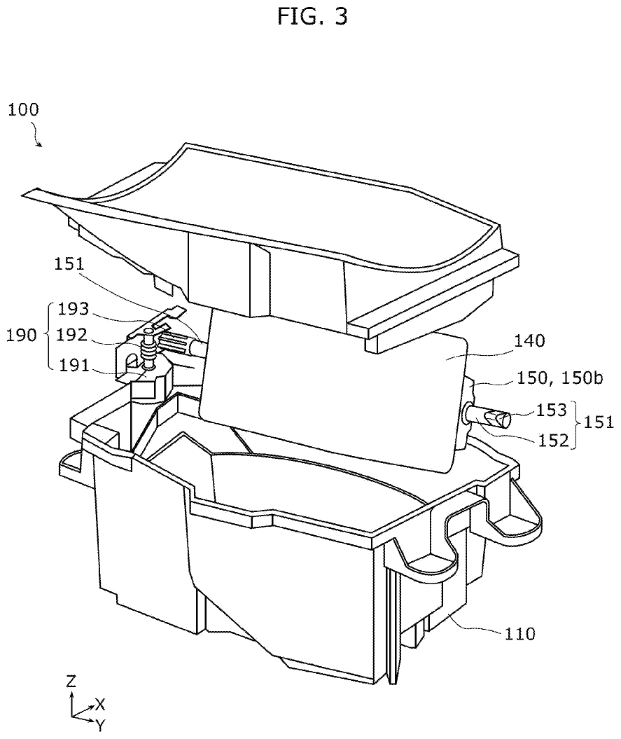

### [FIG. 3]

FIG. 3 is a perspective view of the head-up display according to the embodiment where some of parts are separated.

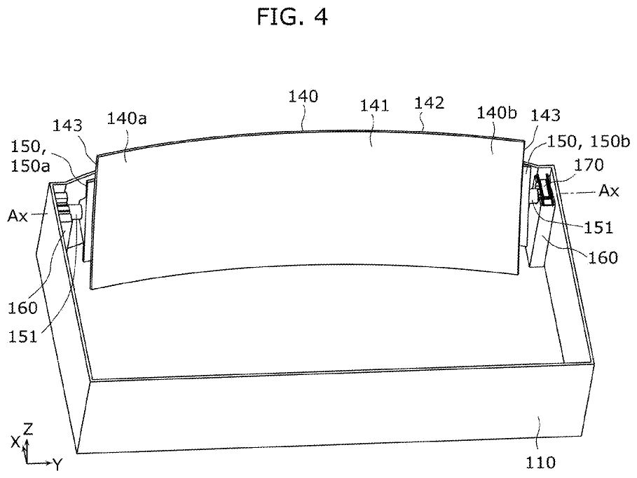

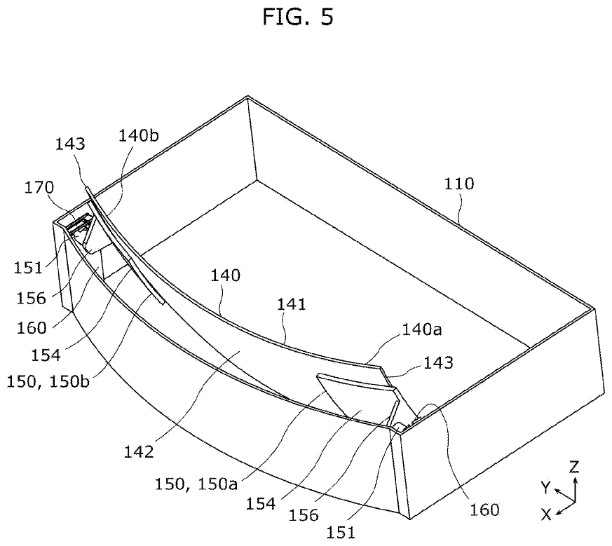

### [FIG. 4]

FIG. 4 is a schematic perspective view of the head-up display according to the embodiment, viewing a mirror etc. from a reflective surface side.

### [FIG. 5]

FIG. 5 is a schematic perspective view of the head-up display according to the embodiment, viewing the mirror etc. from diagonally above from a back surface side.

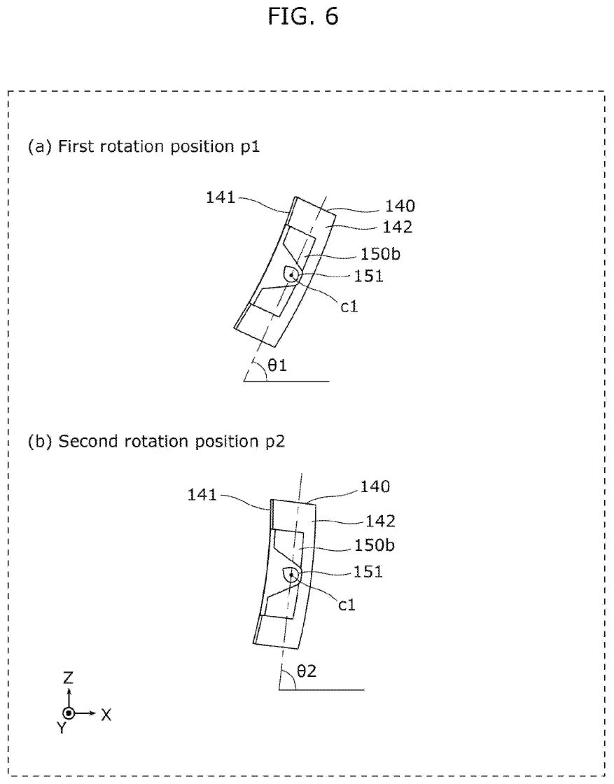

### [FIG. 6]

FIG. 6 is a diagram schematically illustrating a first rotation position and a second rotation position of the mirror in the head-up display according to the embodiment.

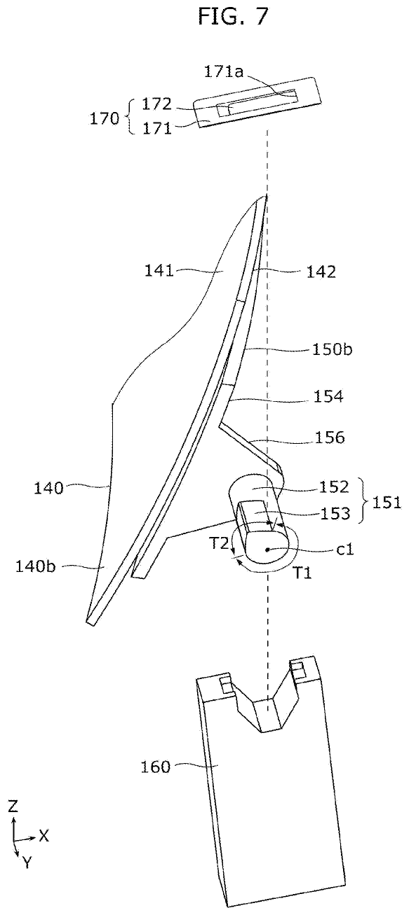

### [FIG. 7]

FIG. 7 is an exploded perspective view of a rotational shaft, a bearing, and a pressing component of the head-up display according to the embodiment.

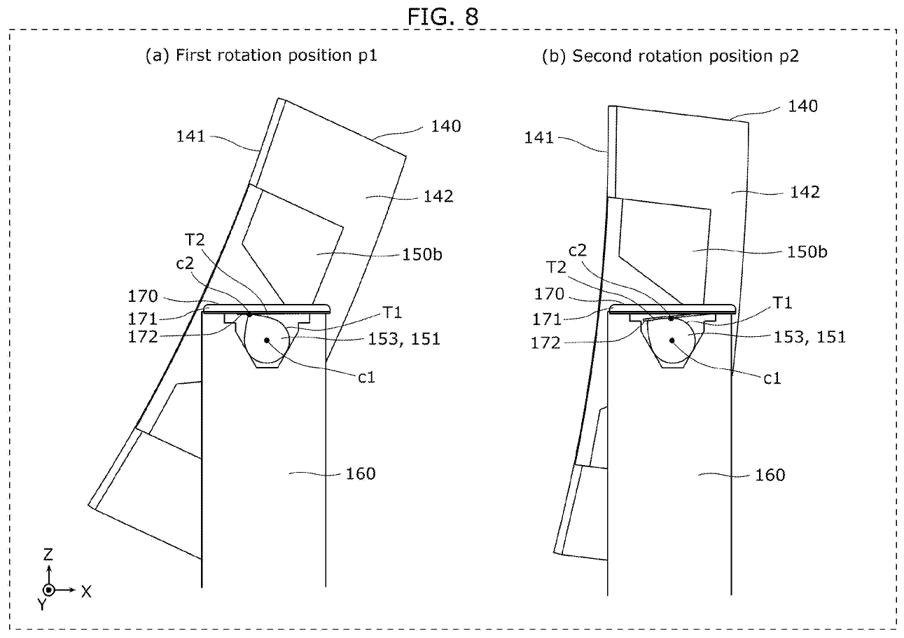

### [FIG. 8]

FIG. 8 is a diagram illustrating side views of the rotational shaft, the bearing, and the pressing component in the first rotation position and the second rotation position.

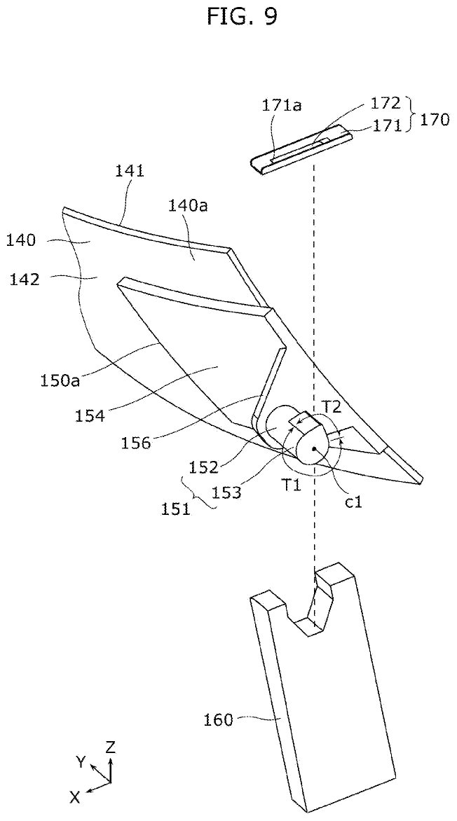

### [FIG. 9]

FIG. 9 is an exploded perspective view of a rotational shaft, a bearing, and a pressing component of a head-up display according to a variation of the embodiment.

### DESCRIPTION OF EMBODIMENTS

A mirror of a head-up display is rotatably actuated by an actuation mechanism including a motor and a plurality of gears, for example. In the actuation mechanism, an elastic force produced by a spring and the like is applied to a gear to set the gear in a predetermined rotation direction to prevent backlash in gears. This prevents a reduction in the accuracy of mirror rotations.

Meanwhile, the head-up display causes the mirror to rotatably move to a rotation position different from a rotation position at which image light is displayed when image light is not displayed. This is to avoid an exit surface of a display device from which image light exits to be exposed to sunlight for many hours. For this reason, a difference between a rotation angle of the gears and the like when image light is displayed and a rotation angle of the gears and the like when image light is not displayed is large, and thus a force applied by a spring and the like to the gear increases. This causes the gears and the like of the actuation mechanism to wear out, and thus may shorten the lifespan of the head-up display.

In view of the above, the present disclosure provides a head- up display that can prevent shortening of its lifespan.

Hereinafter, embodiments are described in detail with reference to the drawings. Note that the embodiments described below each show a specific example of the present disclosure. The numerical values, shapes, materials, structural elements, the arrangement and connection of the structural elements, steps, orders of the steps, etc. illustrated in the following embodiments are mere examples, and are not intended to limit the present disclosure. Furthermore, among the structural elements in the embodiments below, those not recited in any one of the independent claims representing the most generic concept will be described as optional structural elements.

### [Embodiment]

### [Example of Usage of Head-up Display]

An example of usage of head-up display 100 according to an embodiment will be described with reference to FIG. 1 and FIG. 2.

FIG. 1 is a diagram illustrating an example of usage of head-up display 100 according to the embodiment. FIG. 2 is a diagram illustrating a display area of an image to be displayed by head-up display 100 according to the embodiment.

Head-up display 100 according to the embodiment is configured as an in-vehicle head-up display (HUD), and is provided near the top surface of dashboard 301 of vehicle 300.

This head-up display 100 projects light on area D1 (an area surrounded by a dashed line in FIG. 2) of windshield (front glass) 302 that is a display medium. The light projected on area D1 reflects off windshield 302 illustrated in FIG. 1. The reflection light reflected off windshield 302 travels toward the eye of a vehicle driver who is the user of head-up display 100 sitting on the driver's seat. The vehicle driver perceives the reflection light that has entered their eye as virtual image I1 shown on the opposite side of windshield 302 (outside the vehicle) with actual objects that can be seen through windshield 302 as the background. In this embodiment, the above-described series of events will be represented as head-up display 100 displaying virtual image I1 using windshield 302.

### [Basic Configuration of Head-up Display]

A basic configuration of head-up display 100 will be described with reference to FIG. 1 through FIG. 3.

Head-up display 100 illustrated in FIG. 1 includes casing 110, fixed mirror 130, mirror 140 of a movable type, mirror holders 150, bearings (illustrations omitted), pressing components (illustrations omitted), and display device 200.

FIG. 3 is a perspective view of head-up display 100 in which some of parts are separated. In FIG. 3, mirror 140, mirror holder 150, actuator 190, etc. are illustrated separated from casing 110.

Drawings from FIG. 3 onward, the Z axis direction represents the vertical direction, the X axis direction represents a direction perpendicular to the Z axis direction which is the traveling direction of a vehicle, and the Y axis direction represents a direction perpendicular to both the Z axis direction and the X axis direction (the left-right direction of the vehicle).

As illustrated in FIG. 3, head-up display 100 includes actuator 190 for rotatably actuating mirror 140 by means of mirror holders 150. Actuator 190 is fixed to casing 110, and applies, to rotational shafts 151 of mirror holders 150, rotation power for changing an angle of mirror 140.

Actuator 190 includes motor 191, gear 192 connected to a motor shaft of motor 191, and gear 193 provided on rotational shaft 151. Gear 192 is, for example, a worm gear, and gear 193 is, for example, a worm wheel. Gears 192 and 193 are in mesh. Gears 192 and 193 are power transmission components for transmitting rotation power generated by motor 191. The rotation power generated by motor 191 is transmitted to rotational shafts 151 of mirror holders 150 by means of gears 192 and 193. With this rotation power, mirror 140 and mirror holders 150 rotate about rotational shafts 151.

Note that in head-up display 100, power for setting gear 193 in a predetermined rotation direction is applied for preventing a reduction in the accuracy of rotations resulting from backlash in gear 192 and gear 193. However, the power for setting gear 193 in a predetermined rotation direction is not directly applied to gear 193, but is applied to gear 193 through one of rotational shaft 151, the other of rotational shaft 151, etc. This will be described later.

Casing 110 illustrated in FIG. 1 accommodates fixed mirror 130, mirror 140 of a movable type, mirror holders 150, and display device 200. Casing 110 includes (i) casing upper portion 111 that is the upper portion of a box-like body in a substantially parallelepiped shape elongated in the Y axis direction and includes opening 114, (ii) casing lower portion 112 that is the lower portion of the box-like body, and (iii) light-transmissive cover 113 that seals opening 114 in casing upper portion 111. Casing upper portion 111 and casing lower portion 112 together create space S1 in casing 110. Casing 110 includes, for example, a resin material such as polybutylene terephthalate (PBT), but may include metal.

Display device 200 is one example of a picture generation unit (PGU) that emits light from a light source to a liquid crystal panel to emit an image. Note that although the whole display device 200 is accommodated in casing 110 as shown in FIG. 2, only part of display device 200 may be accommodated in casing 110 or display device 200 may be provided outside casing 110.

Fixed mirror 130 is fixed inside casing 110. Fixed mirror 130 reflects image light emitted from display device 200 toward mirror 140. Fixed mirror 130 is a quadrilateral, plate-like component elongated in the Y axis direction. Fixed mirror 130 includes, for example, a glass material.

Mirror 140 of a movable type further reflects image light reflected by fixed mirror 130. The image light reflected off mirror 140 is projected on windshield 302 through opening 114. This displays virtual image I1 that appears to be shown on the opposite side of windshield 302 (outside a vehicle) from a view of a vehicle driver sitting on the driver's seat.

### [Detailed Configuration of Head-up Display]

A detailed configuration of head-up display 100 will be described with reference to FIG. 4 through FIG. 8.

FIG. 4 is a schematic perspective view of head-up display 100, viewing mirror 140 etc. from the reflective surface 141 side. FIG. 5 is a schematic perspective view of head-up display 100, viewing mirror 140 etc. from diagonally above from the back surface 142 side. Illustrations of actuator 190 etc. are omitted from these drawings.

As illustrated in FIG. 4, mirror 140 is rotatably supported about axis Ax of rotational shafts 151. In this embodiment, axis Ax of rotational shafts 151 is parallel to the Y axis direction.

Mirror 140 is a concave mirror having a free-form surface. To be more specific, mirror 140 has a cross section in a concave shape as viewed from above or below mirror 140, and has a cross section in a concave shape as viewed from an axis Ax direction.

Mirror 140 includes, for example, a glass material, and is in a plate-like shape. Mirror 140 includes reflective surface 141 that reflects image light, back surface 142 opposite reflective surface 141, and side surfaces 143 that join reflective surface 141 and back surface 142 together. Reflective surface 141 and back surface 142 are parallel to each other, and side surfaces 143 are perpendicular to reflective surface 141 and back surface 142. Side surfaces 143 are provided on the perimeter of mirror 140. In addition, as mirror 140 is viewed from the back surface 142 side, mirror 140 is in a rectangular shape and has two long sides extending along the axis Ax direction and two short sides perpendicular to the axis Ax direction. Mirror 140 has, in the axis Ax direction, two end portions which are one end portion 140a and the other end portion 140b on the opposite side of one end portion 140a.

Mirror holders 150 support mirror 140 from the back surface 142 side of mirror 140. Mirror holders 150 include, for example, a resin material such as polycarbonate (PC). Mirror holders 150 are two mirror holders divided for a weight reduction. Mirror holders 150 are mirror holder 150a that is one of the two mirror holders and mirror holder 150b that is the other of the two mirror holders. Mirror holder 150a that is one of the two mirror holders and mirror holder 150b that is the other of the two mirror holders are disposed with a predetermined space therebetween in the axis Ax direction.

Mirror holder 150a that is one of the two mirror holders supports one end portion 140a of mirror 140 in a state in which mirror holder 150a is supported by one of bearings 160. Mirror holder 150b that is the other of the two mirror holders supports the other end portion 140b of mirror 140 in a state in which mirror holder 150b is supported by the other of bearings 160 different from the above-mentioned bearing 160. Note that the one of bearings 160 and the other of bearings 160 are parts of casing 110 and are integrated with casing 110.

Each of mirror holders 150a and 150b includes rotational shaft 151 for rotating mirror 140, contact surface portion 154 in contact with mirror 140, and projecting plate portion 156 projecting from contact surface portion 154 and connecting to rotational shaft 151.

Contact surface portions 154 support mirror 140 along back surface 142 of mirror 140. Each contact surface portion 154 is a curved plate and is adhered to a portion of back surface 142 of mirror 140 with an adhesive or a double-sided adhesive tape. An area size of each contact surface portion 154 of mirror holder 150 is smaller than an area size of back surface 142 of mirror 140.

Projecting plate portions 156 project from respective contact surface portions 154 toward a side opposite the reflective surface 141 side, and intersect with axis Ax of rotational shafts 151. Each projecting plate portion 156 is a reinforcement rib for reinforcing contact surface portion 154 and rotational shaft 151. Each projecting plate portion 156 is connected to one end of rotational shaft 151.

Rotational shafts 151 are disposed outward of respective side surfaces 143 as viewed from the back surface 142 side of mirror 140. Rotational shafts 151 are disposed on axis Ax. Each rotational shaft 151 has one end connected to projecting plate portion 156 and the other end supported by bearing 160.

FIG. 6 is a diagram schematically illustrating first rotation position p1 and second rotation position p2 of mirror 140 in head-up display 100. FIG. 6 illustrates a diagram of mirror 140 and mirror holder 150b which are viewed from the axis Ax direction. Note that illustrations of bearing 160 and pressing component 170 are omitted from FIG. 6.

First rotation position p1 shown in (a) in FIG. 6 is a rotation position of mirror 140 when display device 200 emits image light. When display device 200 emits image light is when power-supply electric power is supplied to head-up display 100, for example. In first rotation position p1, mirror 140 projects an image in accordance with a rotation position of mirror 140. Note that first rotation position p1 varies depending on a user, and thus takes a predetermined range of rotation angles.

Second rotation position p2 shown in (b) in FIG. 6 is a rotation position of mirror 140 when display device 200 does not emit image light. When display device 200 does not emit image light is when power-supply electric power is not supplied to head-up display 100, for example. In second rotation position p2, mirror 140 avoids sunlight entering display device 200. Although a difference between rotation angle θ1 of first rotation position p1 and rotation angle 82 of second rotation position p2 varies depending on a display position that suits a user's eye level, rotation angle 01 and rotation angle 82 each range from 15° to 30° , for example.

FIG. 7 is an exploded perspective view of rotational shaft 151, bearing 160, and pressing component 170 of head-up display 100. FIG. 8 is a diagram illustrating side views of rotational shaft 151, bearing 160, and pressing component 170 in first rotation position p1 and in second rotation position p2. FIG. 8 shows a diagram of rotational shaft 151, bearing 160, and pressing component 170 which are viewed from the axis Ax direction.

Hereinafter, rotational shaft 151, bearing 160, and pressing component 170 provided on the other end portion 140b side of mirror 140 will be used as examples for describing the embodiment. Note that the one end portion 140a side of mirror 140 may have the same configuration.

Bearing 160 illustrated in FIG. 7 and FIG. 8 is a component that rotatably supports rotational shaft 151 of mirror holder 150b. A cross section of bearing 160 is in a V-shaped groove shape. Rotational shaft 151 is pressed against the groove of bearing 160 by pressing component 170. In addition, rotational shaft 151 is rotatably supported by bearing 160 in a state in which rotational shaft 151 is pressed against the groove by pressing component 170.

As illustrated in FIG. 7, rotational shaft 151 includes shaft body 152 in a cylindrical shape and eccentric portion 153 including an area in which a distance from rotation center c1 changes. Rotation center c1 is the center about which rotational shaft 151 rotates. As viewed from the axis Ax direction, rotation center c1 matches axis Ax.

Shaft body 152 extends along the axis Ax direction, and has one end connected to projecting plate portion 156. The other end of shaft body 152 is provided with eccentric portion 153. Eccentric portion 153 is in a cam-like shape, and is rotatable and slidable with respect to the groove of bearing 160.

Eccentric portion 153 includes outer peripheral area T1 in which a distance from rotation center c1 is constant, and outer peripheral area T2 in which a distance from rotation center c1 changes.

Outer peripheral area T1 is arcuate in shape as viewed from the axis Ax direction. The arcuate outer peripheral area T1 is in contact with the groove of bearing 160.

Outer peripheral area T2 is non-arcuate in shape as viewed from the axis Ax direction. The non-arcuate outer peripheral area T2 has a distance from rotation center c1 longer than a distance from rotation center c1 in the arcuate outer peripheral area T1. The non-arcuate outer peripheral area T2 has two end portions adjacent to the arcuate outer peripheral area T1 and the center portion between the two end portions. In the non-arcuate outer peripheral area T2, a distance from rotation center c1 gradually increases as shifting from an end portion to the center portion. The non-arcuate outer peripheral area T2 is not in contact with bearing 160, but is in contact with pressing component 170.

Rotational shaft 151 according to the embodiment is rotatable within a range of rotation angles at which the arcuate outer peripheral area T1 is in contact with bearing 160. Consequently, pressing component 170 presses eccentric portion 153 such that the arcuate outer peripheral area T1 comes into contact with bearing 160.

Pressing component 170 includes base portion 171 fixed to casing 110, and flat spring portion 172 connected to base portion 171.

Base portion 171 is in a flat plate shape and has a quadrilateral opening. Flat spring portion 172 is connected to opening side 171a that is one of sides of the quadrilateral opening.

Flat spring portion 172 is in a rectangular shape smaller than the opening. Flat spring portion 172 has one end connected to opening side 171a of base portion 171 and the other end elastically deformable with opening side 171a as a base point. Flat spring portion 172 is brought into contact with eccentric portion 153, and presses eccentric portion 153 using an elastic force. For example, in a natural state in which no load is applied to flat spring portion 172, an angle (acute angle) of flat spring portion 172 relative to base portion 171 is about 30°. Accordingly, flat spring portion 172 has an elastic force that increases with a decrease in the angle relative to base portion 171.

When mirror 140 changes its position from first rotation position p1 to second rotation position p2, flat spring portion 172 is brought into a state of contacting the vicinity of an end portion of the non-arcuate outer peripheral area T2 from a state of contacting the vicinity of the center portion of the non-arcuate outer peripheral area T2.

As illustrated in (a) in FIG. 8, pressing component 170 is in contact with the vicinity of the center portion of the non-arcuate outer peripheral area T2 in first rotation position p1. In this rotation position, pressing component 170 presses eccentric portion 153 in a direction displaced from rotation center cl. A pressing force in the direction displaced from rotation center cl is resolved into, for example, a force in a direction toward rotation center cl and a force in a direction for causing rotational shaft 151 to rotate. The force in the direction toward rotation center cl acts as a force for pressing rotational shaft 151 against bearing 160, and the force in the direction for causing rotational shaft 151 of mirror holder 150b to rotate acts as a force for setting gear 193 through mirror 140 and rotational shaft 151 of mirror holder 150b to prevent backlash.

As illustrated in (b) in FIG. 8, pressing component 170 is in contact with the vicinity of an end portion of the non-arcuate outer peripheral area T2 in second rotation position p2. In this rotation position, pressing component 170 presses eccentric portion 153 in a direction displaced from rotation center cl. A pressing force in the direction displaced from rotation center cl is resolved into, for example, a force in a direction toward rotation center cl and a force in a direction for causing rotational shaft 151 to rotate.

As illustrated in FIG. 8, a distance between contact point c2 at which flat spring portion 172 and rotational shaft 151 come into contact and rotation center cl of rotational shaft 151 is shorter in second rotation position p2 than in first rotation position pl. Accordingly, a pressing force of pressing component 170 pressing eccentric portion 153, which is an elastic force produced by flat spring portion 172, is smaller in second rotation position p2 than in first rotation position p1. In other words, a force applied to gear 193 through rotational shaft 151, etc. is smaller when image light is not emitted than when image light is emitted. With this, it is possible to prevent wear of gears 192 and 193 (see FIG. 3) and the like that are power transmission components when image light is not emitted.

Therefore, shortening of the lifespan of head-up display 100 can be prevented.

### [Variation of Embodiment]

FIG. 9 is an exploded perspective view of rotational shaft 151, bearing 160, and pressing component 170 of head-up display 100 according to a variation.

In the variation, rotational shaft 151, bearing 160, and pressing component 170 on the one end portion 140a side of mirror 140 have the same configuration as described in the embodiment. To be more specific, in the variation, rotational shaft 151 of mirror holder 150a, which is one of the two mirror holders, includes shaft body 152 in a cylindrical shape and eccentric portion 153 including an area in which a distance from rotation center cl changes. Eccentric portion 153 includes outer peripheral area T1 in which a distance from rotation center cl is constant and outer peripheral area T2 in which a distance from rotation center cl changes. Even in the variation, Wear of gears 192 and 193, etc. which are power transmission components can also be prevented in the variation, and therefore shortening of the lifespan of head-up display 100 can be prevented.

Note that in head-up display 100, not only rotational shaft 151, bearing 160, and pressing component 170 on the one end portion 140a side of mirror 140 have the same configurations as described in the embodiment, but also rotational shafts 151, bearings 160, and pressing components 170 on both the one end portion 140a side and the other end portion 140b side of mirror 140 may have the same configuration as described in the embodiment. In this case, positions of rotational shaft 151 and eccentric portion 153 on the one end portion 140a of mirror 140 and positions of rotational shaft 151 and eccentric portion 153 on the other end portion 140b side of mirror 140 may be aligned as viewed from the axis Ax direction.

### [Conclusions]

Head-up display 100 according to the embodiment includes: display device 200 that emits image light; mirror 140 that reflects the image light; mirror holder 150 that supports mirror 140 and includes rotational shaft 151; bearing 160 that rotatably supports rotational shaft 151; and pressing component 170 that presses a portion of rotational shaft 151. Rotational shaft 151 includes eccentric portion 153 including an area in which a distance from rotation center c1 changes. Pressing component 170 presses eccentric portion 153.

With this configuration, a portion of eccentric portion 153 which is to be pressed can be changed in accordance with a rotation angle of rotational shaft 151. Accordingly, application of an excessive force to a power transmission component connected to rotational shaft 151 can be prevented, and therefore wear of the power transmission component can be prevented. With this, shortening of the lifespan of head-up display 100 can be prevented.

In addition, eccentric portion 153 may include arcuate outer peripheral area T1 in which a distance from rotation center c1 is constant, and non-arcuate outer peripheral area T2 in which a distance from rotation center c1 changes.

With this configuration, an outer peripheral area to be pressed can be changed in eccentric portion 153 in accordance with a rotation angle of rotational shaft 151. Accordingly, application of an excessive force to a power transmission component connected to rotational shaft 151 can be prevented, and therefore wear of the power transmission component can be prevented. With this, shortening of the lifespan of head-up display 100 can be prevented.

Moreover, pressing component 170 may press eccentric portion 153 such that arcuate outer peripheral area T1 comes into contact with bearing 160.

Pressing the arcuate outer peripheral area T1 to bearing 160 as described above enables outer peripheral area T1 and bearing 160 to smoothly slide, and therefore wear of eccentric portion 153 and bearing 160 can be prevented. With this, shortening of the lifespan of head-up display 100 can be prevented.

In addition, eccentric portion 153 may be in a cam-like shape.

Eccentric portion 153 in a cam-like shape as described above can apply an appropriate force such that a power transmission component connected to rotational shaft 151 is not readily worn out. With this, shortening of the lifespan of head-up display 100 can be prevented.

Moreover, pressing component 170 may include flat spring portion 172 that presses eccentric portion 153 against bearing 160.

With this, eccentric portion 153 can be appropriately pressed against bearing 160 using flat spring portion 172, and therefore wear of eccentric portion 153 and bearing 160 can be prevented. With this, shortening of the lifespan of head-up display 100 can be prevented.

In addition, mirror 140 is arranged in (i) first rotation position p1 that is a position when display device 200 emits the image light or (ii) second rotation position p2 that is a position when display device 200 does not emit the image light. A pressing force of pressing component 153 pressing eccentric portion 170 may be smaller in second rotation position p2 than in first rotation position p1

With this, wear of a power transmission component connected to rotational shaft 151 can be prevented in second rotation position p2. With this, shortening of the lifespan of head-up display 100 can be prevented.

Moreover, in first rotation position p1, mirror 140 may project an image in accordance with a rotation position of mirror 140. In second rotation position p2, mirror 140 may avoid sunlight entering display device 200.

With this, sunlight can be prevented from entering display device 200 when display device 200 does not emit image light. With this, shortening of the lifespan of head-up display 100 can be prevented.

In addition, head-up display 100 further includes actuator 190 that includes gears 192 and 193. Actuator 190 may transmit, to rotational shaft 151, a force for causing rotational shaft 151 to rotate.

With this configuration, application of an excessive force to actuator 190 through rotational shaft 151 can be prevented, and therefore wear of gears 192 and 193 of actuator 190 can be prevented. With this, shortening of the lifespan of head-up display 100 can be prevented.

Moreover, mirror 140 includes one end portion 140a and the other end portion 140b at respective end portions in the axis Ax direction of rotational shaft 151. Mirror holder 150 may consist of first mirror holder 150a that supports one end portion 140a of mirror 140 and second mirror holder 150b that supports the other end portion 140b of mirror 140.

Accordingly, the both end portions of mirror 140 are appropriately supported by first mirror holder 150a and second mirror holder 150b. With this, production of vibrations in mirror 140 can be reduced. With this, shortening of the lifespan of head-up display 100 can be prevented.

In addition, mirror 140 may be a concave mirror.

Accordingly, production of vibrations in mirror 140 that is a concave mirror can be reduced. With this, shortening of the lifespan of head-up display 100 can be prevented.

Moreover, head-up display 100 may further include fixed mirror 130 different from mirror 140. Fixed mirror 130 may reflect, toward mirror 140, the image light emitted from display device 200.

With this, shortening of the lifespan of head-up display 100 can be prevented, even for head-up display 100 including fixed mirror 130.

### [Other embodiments]

The above-described embodiments have presented an example in which flat spring portion 172 of pressing component 170 presses eccentric portion 153, but the present disclosure is not limited to this example. For example, instead of a flat spring portion of pressing component 170, a compression coil or a torsion spring may be used to press eccentric portion 153.

The above-described embodiments have presented an example in which bearing 160 has a V-shaped groove shape, but the present disclosure is not limited to this example. A bearing may have a U-shaped groove shape.

The above-described embodiments have presented an example in which eccentric portion 153 is in contact with bearing 160, but the present disclosure is not limited to this example. For example, when shaft body 152 is in contact with and supported by bearing 160, eccentric portion 153 may have a configuration in which a pressing force is applied to a portion other than a portion in contact with bearing 160. In addition, bearing 160 supporting shaft body 152 need not have a V-shaped groove. Bearing 160 may be a ball bearing or the like.

The above-described embodiments have presented an example in which mirror holders 150 are two mirror holders, which are mirror holders 150a and 150b, but the present disclosure is not limited to this example. For example, a mirror holder may be a single mirror holder covering the entire back surface of mirror 140.

The above-described embodiments have presented an example in which mirror 140 is in a rectangular shape as mirror 140 is viewed from the back surface 142 side, but the present disclosure is not limited to this example. For example, mirror 140 may be in a trapezoidal shape having the top side and the bottom side extending along the axis Ax direction of rotational shaft 151.

The above-described embodiments have presented an example in which flat spring portion 172 comes into contact with the vicinity of an end portion of the non-arcuate outer peripheral area T2 in second rotation position p2, but the present disclosure is not limited to this example. For example, flat spring portion 172 may come into contact with the vicinity of an end portion of the arcuate outer peripheral area T1 adjacent to the non-arcuate outer peripheral area T2 in second rotation position p2.

In addition, head-up display 100 may have the following features. The following provides features of a head-up display that has been described based on the above-described embodiments.

### [Technique 1]

A head-up display comprising:
a display device that emits image light;
a mirror that reflects the image light;
a mirror holder that supports the mirror and includes a rotational shaft;
a bearing that rotatably supports the rotational shaft; and
a pressing component that presses a portion of the rotational shaft, wherein
the rotational shaft includes an eccentric portion including an area in which a distance from a rotation center changes, and
the pressing component presses the eccentric portion.

### [Technique 2]

The head-up display according to technique 1, wherein
the eccentric portion includes an arcuate outer peripheral area in which a distance from the rotation center is constant, and a non-arcuate outer peripheral area in which a distance from the rotation center changes.

### [Technique 3]

The head-up display according to technique 2, wherein
the pressing component presses the eccentric portion such that the arcuate outer peripheral area comes into contact with the bearing.

### [Technique 4]

The head-up display according to any one of techniques 1 to 3, wherein
the eccentric portion is in a cam-like shape.

### [Technique 5]

The head-up display according to any one of techniques 1 to 4, wherein
the pressing component includes a flat spring portion that presses the eccentric portion against the bearing.

### [Technique 6]

The head-up display according to any one of techniques 1 to 5, wherein
the mirror is arranged in (i) a first rotation position that is a position when the display device emits the image light or (ii) a second rotation position that is a position when the display device does not emit the image light, and
a pressing force of the pressing component pressing the eccentric portion is smaller in the second rotation position than in the first rotation position.

### [Technique 7]

The head-up display according to technique 6, wherein
in the first rotation position, the mirror projects an image in accordance with a rotation position of the mirror, and
in the second rotation position, the mirror avoids sunlight entering the display device.

### [Technique 8]

The head-up display according to any one of techniques 1 to 7, further comprising:
an actuator that includes a plurality of gears, wherein
the actuator transmits, to the rotational shaft, a force for causing the rotational shaft to rotate.

### [Technique 9]

The head-up display according to any one of techniques 1 to 8, wherein
the mirror includes one end portion and an other end portion at respective end portions in an axis direction of the rotational shaft, and
the mirror holder comprises a first mirror holder that supports the one end portion of the mirror and a second mirror holder that supports the other end portion of the mirror.

### [Technique 10]

The head-up display according to any one of techniques 1 to 9, wherein the mirror is a concave mirror.

### [Technique 11]

The head-up display according to any one of techniques 1 to 10, further comprising:
a fixed mirror different from the mirror, wherein
the fixed mirror reflects, toward the mirror, the image light emitted from the display device.

Hereinbefore, head-up displays according to the present disclosure has been described based on the above-described embodiments, but the present disclosure is not limited to these embodiments. As long as the following embodiments do not depart from the subject matter of the present disclosure, the following embodiments may be within a range of one or more aspects of the embodiments of the present disclosure: embodiments achieved by applying various modifications conceivable to those skilled in the art to each of the above-described embodiments; and embodiments achieved by combining structural elements in different embodiments.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2022-121393 filed on Jul. 29, 2022.

### Industrial Applicability

The present disclosure is useful as head-up displays to be provided in vehicles.

1. A head-up display comprising:
a display device that emits image light;
a mirror that reflects the image light;
a mirror holder that supports the mirror and includes a rotational shaft;
a bearing that rotatably supports the rotational shaft; and
a pressing component that presses a portion of the rotational shaft, wherein
the rotational shaft includes an eccentric portion including an area in which a distance from a rotation center changes, and
the pressing component presses the eccentric portion.

2. The head-up display according to claim 1, wherein
the eccentric portion includes an arcuate outer peripheral area in which a distance from the rotation center is constant, and a non-arcuate outer peripheral area in which a distance from the rotation center changes.

3. The head-up display according to claim 2, wherein
the pressing component presses the eccentric portion such that the arcuate outer peripheral area comes into contact with the bearing.

4. The head-up display according to claim 1, wherein
the eccentric portion is in a cam-like shape.

5. The head-up display according to claim 1, wherein
the pressing component includes a flat spring portion that presses the eccentric portion against the bearing.

6. The head-up display according to claim 1, wherein
the mirror is arranged in (i) a first rotation position that is a position when the display device emits the image light or (ii) a second rotation position that is a position when the display device does not emit the image light, and
a pressing force of the pressing component pressing the eccentric portion is smaller in the second rotation position than in the first rotation position.

7. The head-up display according to claim 6, wherein
in the first rotation position, the mirror projects an image in accordance with a rotation position of the mirror, and
in the second rotation position, the mirror avoids sunlight entering the display device.

8. The head-up display according to claim 1, further comprising:
an actuator that includes a plurality of gears, wherein
the actuator transmits, to the rotational shaft, a force for causing the rotational shaft to rotate.

9. The head-up display according to claim 1, wherein
the mirror includes one end portion and an other end portion at respective end portions in an axis direction of the rotational shaft, and
the mirror holder comprises a first mirror holder that supports the one end portion of the mirror and a second mirror holder that supports the other end portion of the mirror.

10. The head-up display according to claim 9, wherein
the mirror is a concave mirror.

11. The head-up display according to claim 1, further comprising:
a fixed mirror different from the mirror, wherein
the fixed mirror reflects, toward the mirror, the image light emitted from the display device.
